(19) United States
(12) Patent Application Publication
(10) Pub. No.: US 2019/0385528 A1
(43) Pub. Date: Dec. 19, 2019

(54) PIXEL DRIVING CIRCUIT AND LIQUID CRYSTAL DISPLAY DEVICE THEREOF

(71) Applicant: Wuhan China Star Optoelectronics Semiconductor Display Technology Co., Ltd., Wuhan, Hubei (CN)

(72) Inventors: Xueshun HOU, Shenzhen, Guangdong (CN); Xue LI, Shenzhen, Guangdong (CN)

(21) Appl. No.: 15/746,455

(22) PCT Filed: Dec. 19, 2017
(86) PCT No.: PCT/CN2017/117177

§ 371 Date: Jan. 22, 2018

(30) Foreign Application Priority Data
Nov. 15, 2017 (CN) 201711143603.7

(51) Int. Cl. G09G 3/3258; G09G 3/36

(52) U.S. Cl. CPC G09G 3/3258; G09G 3/3696; G09G 2300/0842; G09G 2310/08; G09G 2320/0233

(57) ABSTRACT

Disclosed is a pixel driving circuit and a liquid crystal display device thereof being implemented in a 6T2C structure. The pixel driving circuit includes a scanning switch (T1), a first reset switch (T2), a second reset switch (T3); a third reset switch (T4), a control switch (T5), a driving transistor (T6), an organic light-emitting diode (OLED), a storage capacitor (C1) and a coupling capacitor (C2). With the embodiment of the disclosure, the drift of the threshold voltage of the driving thin-film transistor can be compensated to enhance the uniformity of the display screen of OLED and promote display quality.

### RELATED APPLICATIONS

The present application is a National Phase of International Application Number PCT/CN2017/117177, filed Dec. 19, 2017, and claims the priority of China Application No. CN 201711143603.7, filed Nov. 15, 2017.

### FIELD OF THE DISCLOSURE

The disclosure relates to the field of display technology, and more particularly to a pixel driving circuit and a liquid crystal display device thereof.

### BACKGROUND

Organic light-emitting diode (OLED) display device has advantages in terms of low power consumption, wide color gamut, high luminance, high resolution, wide viewing angle, and fast response. The OLED display device can be categorized into the passive matrix OLED (PMOLED) and the active matrix OLED (AMOLED) depending on the mode of driving. Particularly, AMOLED is classified as an active display as its pixels are arrayed in matrix. The AMOLED is featured by high illuminating efficiency, and is usually employed in large-scale display with high definition.

AMOLED is a current-driven element. When a current is flowing through an OLED, the OLED emit lights and the luminance of the OLED is determined by the current flowing through the OLED. Most of the contemporary integrated circuits (ICs) are configured to transmit voltage signals. As a result, the pixel driving circuit of AMOLED is required to perform the operation of transforming a voltage signal into a current signal. The conventional pixel driving circuit for AMOLED is generally constructed in a 2T1C structure, i.e. a structure consisting of two thin-film transistors and a capacitor to transform voltage into current.

The conventional pixel driving circuit employing the 2T1C structure is sensitive to the threshold voltage and channel mobility of thin-film transistors, the turn-on voltage and quantum efficiency of the organic light-emitting diode, and the transient process of the power source. The threshold voltage of the driving thin-film transistor would drift with the progress of work time. In this way, the illumination of the organic light-emitting diode would be unstable to cause luminance difference of the pixel driving circuit, thereby degrading the display quality.

### SUMMARY

An embodiment of the invention provides a pixel driving circuit for compensating the drift of the threshold voltage of the driving thin-film transistor so as to enhance the uniformity of the display screen of the OLED and promote display quality.

According to a first aspect of the invention, an embodiment of the invention provides a pixel driving circuit, which includes a scanning switch, a first reset switch, a second reset switch, a third reset switch, a control switch, a driving transistor, an organic light-emitting diode, and a storage capacitor and a coupling capacitor;

wherein a first end of the coupling capacitor is connected to a power line;

wherein a source of the scanning switch is connected to a data line, a gate of the scanning switch is connected to a scan control line, and a drain of the scanning switch is connected to a second end of the coupling capacitor and a first end of the storage capacitor;

a source of the first reset switch is connected to a second end of the coupling capacitor and the first end of the storage capacitor, a gate of the first reset switch is connected to a reset signal, and a drain of the first reset switch is connected to a drain of the control switch and a source of the driving transistor;

a source of the second reset switch is connected to a reference voltage, a gate of the second reset switch is connected to the reset signal, and a drain of the second reset switch is connected to a source of the third reset switch and a second end of the storage capacitor;

the source of the third reset switch is connected to the drain of the second reset switch and the second end of the storage capacitor, a gate of the third reset switch is connected to the reset signal, and a drain of the third reset switch is connected to the drain of the driving transistor and an anode of the organic light emitting diode;

a source of the control switch is connected to the power line and the first end of the coupling capacitor, a gate of the control switch is connected to a driving signal; and the drain of the control switch is connected to the drain of the first reset switch and the source of the driving transistor;

the source of the driving transistor is connected to the drain of the first reset switch and the drain of the control switch, the drain of the driving transistor is connected to the third reset switch and the anode of the organic light-emitting diode, and a gate of the driving transistor is connected to the second end of the storage capacitor.

According to a second aspect of the invention, an embodiment of the invention provides a liquid crystal display device employing a pixel driving circuit enumerated in the aforementioned first aspect of the invention.

With the aforementioned pixel driving circuit, the embodiment of the invention is able to first store the threshold voltage of the driving transistor in the gate-to-source voltage of the driving transistor, and thus offset the influence of the threshold voltage according to the saturation current equation of the organic light-emitting diode. In this way, the current flowing through the organic light-emitting diode will no longer be affected by the threshold voltage of the driving thin-film transistor, such that the drift of the threshold voltage of the driving thin-film transistor can be compensated. This would enhance the uniformity of the display screen of OLED and promote display quality.

### BRIEF DESCRIPTION OF THE DRAWINGS

To illustrate the technological scheme embodying the embodiment of the invention in a clear manner, the accompanying drawings showing the embodiment of the invention will be briefed in the following. Apparently, the accompanying drawings stated below form some embodiments of the invention. An artisan having ordinary skill in the art can devise other drawings based on the accompanying drawings without exerting non-inventive laboring. In the figures:

FIG. 1 is a schematic diagram showing the circuitry of a pixel driving circuit according to an embodiment of the invention;

FIG. 2 is a schematic diagram showing the equivalent circuit of a pixel driving circuit operating in the reset phase according to an embodiment of the invention;

FIG. 3 is a schematic diagram showing the equivalent circuit of a pixel driving circuit operating in the compensating phase according to an embodiment of the invention;

FIG. 4 is a schematic diagram showing the equivalent circuit of a pixel driving circuit operating in the light-emitting phase according to an embodiment of the invention; and

FIG. 5 is a timing diagram illustrating the driving timing for a pixel driving circuit according to an embodiment of the invention.

### DETAILED DESCRIPTION OF PREFERRED EMBODIMENTS

Next, the technological scheme delineating the embodiment of the invention is described in a clear and complete manner in conjunction with the drawings accompanied herewith. Apparently, the embodiment described herein is taken as part of all possible embodiments of the invention. Based on the embodiment of the invention, alternative embodiments derived from non-inventive laboring by an artisan having ordinary skill in the art are encompassed within the scope of the invention.

It should be understood that the phrases of “including” and “encompassing” mean the existence of the feature, the entirety of the structure, process, operation, element, and/or the assembly of elements described herein, without the intention to exclude the addition or existence of one or more features, the entirety of the structure, processes, operations, elements, and/or the assembly of elements.

It should also be understood that the phrases used throughout the specification of the invention are merely for the purpose of describing specific embodiments without the intention of limiting the scope of the invention. As is the case with the specification and claims, the singular phrases of “a”, “an”, “one”, or “said” are purported to encompass plural forms unless the context specifies otherwise.

It should be further understood that the phrase of “and/or” used throughout the specification and the claims is directed to one or more arbitrary combinations or all possible combinations of related items, and the inclusion of these combinations.

As is used throughout the specification and claims, the phrase of “if” can be construed as “when” or “once” or “in response to the determination” or “in response to the detection” depending on the context. Likewise, the short phrase of “if it is determined” or “if it detects [the condition or event]” can be construed as “once it is determined”, “in response to the determination”, or “once it detects [the condition or event]”, or “in response to the detection of [the condition of event]” depending on the context.

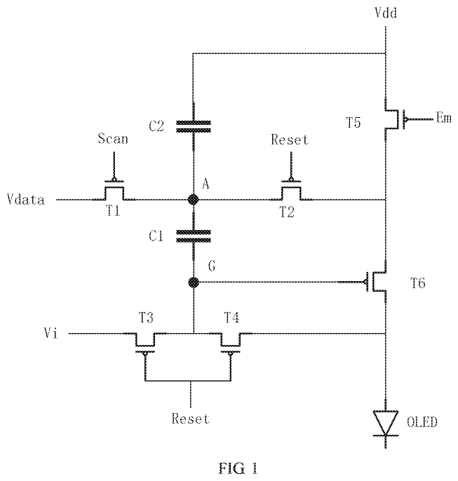

Please refer to FIG. 1, which depicts the circuitry of a pixel driving circuit according to an embodiment of the invention. As shown in FIG. 1, the pixel driving circuit includes a scanning switch T1, a first reset switch T2, a second reset switch T3, a third reset witch T4, a control switch T5, a driving transistor T6, an organic light-emitting diode OLED, and a storage capacitor C1 and a coupling capacitor C2.

The first end of the coupling capacitor C2 is connected to a power line Vdd. The coupling capacitor C2 has two ends, in which one end of the coupling capacitor C2 is termed the first end, and the other end of the coupling capacitor C2 is termed the second end.

The source of the scanning switch T1 is connected to a data line Vdata. The gate of the scanning switch T1 is connected to a scan control line Scan, and the drain of the scanning switch T1 is connected to the second end of the coupling capacitor C2 and the first end of the storage capacitor C1. The storage capacitor C1 has two ends, in which one end of the storage capacitor C1 is termed the first end, and the other end of the storage capacitor C1 is termed the second end.

The source of the first reset switch T2 is connected to the second end of the coupling capacitor C2 and the first end of the storage capacitor C1. The gate of the first reset switch T2 is connected to the reset signal Reset, and the drain of the first reset switch T2 is connected to the drain of the control switch T5 and the source of the driving transistor T6.

The source of the second reset switch T3 is connected to a reference voltage Vi. The gate of the second reset switch T3 is connected to the reset signal Reset, and the drain of the second reset switch T3 is connected to the source of the third reset switch T4 and the second end of the storage capacitor C1.

The source of the third reset switch T4 is connected to the drain of the second reset switch T3 and the second end of the storage capacitor C1. The gate of the third reset switch T4 is connected to the reset signal Reset, and the drain of the third reset switch T4 is connected to the drain of the driving transistor T6 and the anode of the organic light-emitting diode OLED.

The source of the control switch T5 is connected to the power line Vdd and the first end of the coupling capacitor C2. The gate of the control switch T5 is connected to a gate driving signal Em, and the drain of the control switch T5 is connected to the drain of the first reset switch T2 and the source of the driving transistor T6.

The source of the driving transistor T6 is connected to the drain of the first reset switch T2 and the drain of the control switch T5. The drain of the driving transistor T6 is connected to the third reset switch T4 and the anode of the organic light-emitting diode OLED, and the gate of the driving transistor T6 is connected to the second end of the storage capacitor C1.

Concretely speaking, the organic light-emitting diode OLED may be an AMOLED, or a light-emitting element of other types. Concretely speaking, the reset signal Reset and the driving signal Em are provided by a timing controller TCON. The reference voltage Vi is a predetermined constant voltage. Each of the scanning switch T1, the first reset switch T2, the second reset switch T3, the third reset switch T4, the control switch T5, and the driving transistor T6 may be a poly-silicon thin-film transistor, an amorphous-silicon thin-film transistor, a ZnO-based thin-film transistor, or an organic thin-film transistor. It should be understood that the scanning switch T1, the first reset switch T2, the second reset switch T3, the third reset switch T4, the control switch T5, and the driving transistor T6 may be of the same type of transistor or of different types of transistor. For example, these switches may all be organic thin-film transistor. Or otherwise, the scanning switch T1 may be a poly-silicon thin-film transistor, the first reset switch T2 may be an amorphous-silicon thin-film transistor, the second reset switch T3 may be a ZnO-based thin-film transistor, the third reset switch T4 may be an organic thin-film transistor, the control switch T5 may be an organic thin-film transistor, and the driving transistor T6 may be a poly-silicon thin-film transistor.

The pixel driving circuit is set to operate in three working phases: the reset phase, the compensating phase, and the light-emitting phase. Next, the operations in the three working phases will be described.

The reset phase is arranged to set the reset signal Reset at a low voltage level, and set the scan signal Scan and the driving signal Em at a high voltage level. Hence, the first reset switch T2, the second reset switch T3, and the third reset switch T4 are turned on. In the meantime, the scanning switch T1 and the control switch T5 are turned off, and the voltage level at the gate of the driving transistor T6 is reset to a low voltage level.

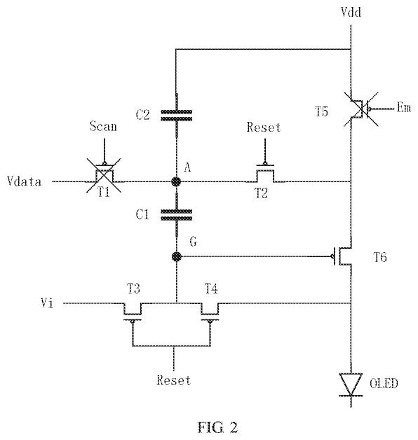

Please refer to FIG. 2, which depicts an equivalent circuit of the pixel driving circuit operating in the reset phase according to an embodiment of the invention. As shown in FIG. 2, the reference voltage Vi is inputted to the pixel driving circuit and the storage capacitor C1 discharges the charges stored therein through the first reset switch T2 and the driving transistor T6, in order to prevent the charges remaining in the previous light-emitting phase from interfering the present light-emitting process. When the charges stored in the storage capacitor C1 is completely discharged, the voltage at the node A is:

V_{A}=V_{data}

Meanwhile, the voltage at the node G is:

V_{G}=Vᵢ

Therefore, the threshold voltage Vth of driving transistor T6 is stored in the storage capacitor C1.

Concretely speaking, before the storage capacitor C1 discharges through the second reset switch T3 and the driving transistor T6, the voltage difference across the storage capacitor C1 (i.e. the voltage difference between the first end and the second end) is larger than the threshold voltage Vth. Optionally, prior to the reset phase, a first initial voltage Va is inputted to the node A and a second initial voltage Vb is inputted to the node G, and the voltage difference between the first initial voltage Va and the second initial voltage Vb is larger than Vth, so that the voltage difference across the storage capacitor C1 is larger than the threshold voltage Vth. Optionally, when the operation of the circuit enters the reset phase, the voltage difference between the node A and the node G is Vth. When the reference voltage Vi is applied to the circuit, the voltage at the node A and the voltage at the node G are both reduced. However, the voltage at the node G will be reduced more than the node A due to the coupling capacitor C2, so that the voltage difference across the storage capacitor C1 is large than the threshold voltage Vth.

The compensating phase is arranged to set the scan signal Scan at a low voltage level, and set the reset signal Reset and the driving signal Em at a high voltage level. Hence, the first reset switch T2, the second reset switch T3, the third reset switch T4, and the control switch T5 are turned off. In the meantime, the scanning switch T1 is turned on. When the voltage level at the gate of the driving transistor T6 reaches the threshold voltage Vth plus the voltage level of the gray-scale data voltage written by the data line Vdata, the driving transistor T6 is turned off.

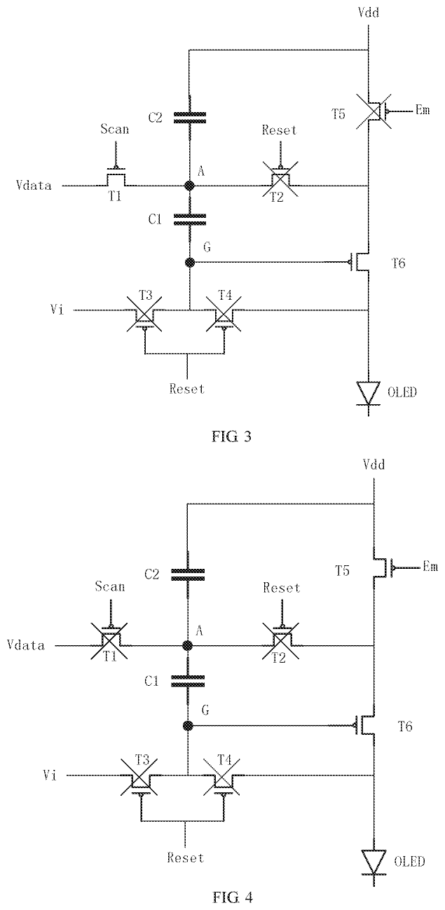

Please refer to FIG. 3, which depicts an equivalent circuit of the pixel driving circuit operating in the compensating phase according to an embodiment of the invention. As shown in FIG. 3, the gray-scale data voltage is written in the node A by the data line Vdata, and the voltage at the node A is:

V_{A}=V_{data}

The voltage at the node G is:

V_{G}=V_{data}Vₜₕ

The gate-to-source voltage Vgs of the driving transistor T6 is:

V_{gs}=V_{g}−Vₛ=V_{G}−Vₛ=V_{data}+Vₜₕ−Vₛ

Thus, the threshold voltage Vth of the driving transistor T6 is stored in the gate-to-source voltage Vgs of the driving transistor T6.

The light-emitting phase is arranged to set the driving signal Em at a low voltage level, and set the reset signal Reset and the scan signal Scan at a high voltage level. Hence, the first reset switch T2, the second reset switch T3, the third reset switch T4, and the scanning switch T1 are turned off. In the meantime, the control switch T5 is turned on. The gate-to-source voltage of the driving transistor T6 drives the organic light-emitting diode OLED to emit lights. During the light-emitting phase, the gate-to-source voltage of the driving transistor T6 remains unchanged until the screen is refreshed with the next frame.

Please refer to FIG. 4, which depicts an equivalent circuit of the pixel driving circuit operating in the light-emitting phase according to an embodiment of the invention. As shown in FIG. 4, the voltage of the power source is coupled to the organic light-emitting diode OLED through the power line Vdd. The source voltage of the driving transistor T6 is:

Vₛ=V_{dd}

The saturation current flowing through the organic light-emitting diode OLED is:

I_{OLED}=K(V_{gs}−Vₜₕ)²

Where K is a parameter related to the driving transistor T6, Vgs is the gate-to-source voltage of the driving transistor T6, and Vth is the threshold voltage of the driving transistor T6. As:

V_{gs}=V_{data}+Vₜₕ−Vₛ

Then:

I_{OLED}=K(V_{dd}−V_{data})²

It can be understood from the above equation that during the light-emitting phase, the saturation current of the organic light-emitting diode OLED will no longer be affected by the threshold voltage Vth of the driving transistor T6. In this way, the pixel driving circuit fulfills the object of compensating the current and thus offset the influence of Vth.

In the pixel driving circuit shown in FIG. 1, the threshold voltage Vth of the driving transistor T6 is first stored in the gate-to-source voltage Vgs of the driving transistor T6, and the influence of the Vth is offset according to the saturation current equation of the organic light-emitting diode OLED, so that the current flowing though the organic light-emitting diode OLED is no longer affected by the threshold voltage Vth of the driving thin-film transistor. Thus, the drift of the threshold voltage of the driving thin-film transistor can be compensated to enhance the uniformity of the display screen of the OLED and promote display quality.

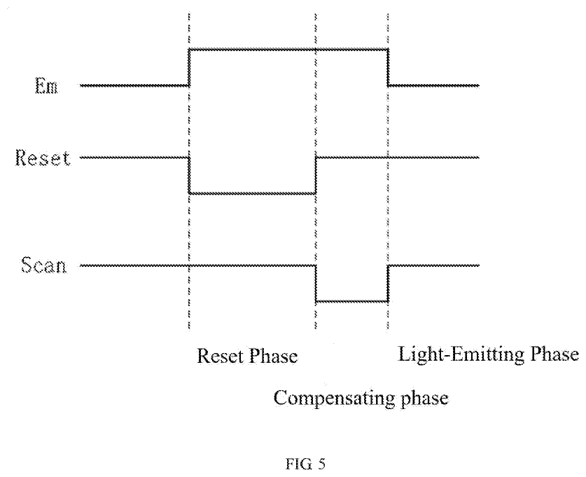

Please refer to FIG. 5, which shows the driving timing for the pixel driving circuit according to an embodiment of the invention. As shown in FIG. 5, during the reset phase, the reset signal Reset is at a low voltage level, and thus it is at an effective voltage level; the driving signal Em and the scan signal Scan are at a high voltage level, and thus they are at an ineffective voltage level. During the compensating phase, the scan signal Scan is at a low voltage level, and thus it is at an effective voltage level; the driving signal Em and the reset signal Reset are at a high voltage level, and thus they are at an ineffective voltage level. During the light-emitting phase, the driving signal Em is at a low voltage level, and thus it is at an effective voltage level; the reset signal Reset and the scan signal Scan are at a high voltage level, and thus they are at an ineffective voltage level. The operation procedure of the driving process can be understood in reference to the operation procedure of the pixel driving circuit illustrated in FIG. 1, and thus it is not intended to give details herein.

In the timing chart for pixel driving operation shown in FIG. 5, the threshold voltage Vth of the driving transistor T6 is first stored in the gate-to-source voltage Vgs of the driving transistor T6. Afterwards, the influence of Vth is offset by the saturation current equation of the organic light-emitting diode OLED. Therefore, the current flowing though the organic light-emitting diode OLED is no longer affected by the threshold voltage Vth of the driving thin-film transistor. Thus, the drift of the threshold voltage of the driving thin-film transistor can be compensated to enhance the uniformity of the display screen of the OLED and promote display quality.

Another embodiment of the invention provides to a liquid crystal display device incorporating a pixel driving circuit illustrated in FIG. 1.

In conclusion, the invention has been disclosed by way of the aforementioned preferred embodiment. However, the preferred embodiment is not to be used to limit the invention. An artisan having ordinary skill in the art is able to make various alterations and modifications to the invention without departing from the spirit and scope of the invention. Hence, the scope of the invention should be defined by the appended claims.

The above descriptions has elaborated a preferred embodiment of the invention. It should be realized that an artisan having ordinary skill in the art is able to make some alterations and modifications to the invention without deviating from the principle of the invention. Nonetheless, these alterations and modifications should be deemed to be within the scope of the invention.

What is claimed is:

1. A pixel driving circuit, comprising:
a scanning switch;
a first reset switch;
a second reset switch;
a third reset switch;
a control switch;
a driving transistor;
an organic light-emitting diode; and
a storage capacitor and a coupling capacitor;
wherein a first end of the coupling capacitor is connected to a power line;
wherein a source of the scanning switch is connected to a data line, a gate of the scanning switch is connected to a scan control line, and a drain of the scanning switch is connected to a second end of the coupling capacitor and a first end of the storage capacitor;
wherein a source of the first reset switch is connected to the second end of the coupling capacitor and the first end of the storage capacitor, a gate of the first reset switch is connected to a reset signal, and a drain of the first reset switch is connected to a drain of the control switch and a source of the driving transistor;
wherein a source of the second reset switch is connected to a reference voltage, a gate of the second reset switch is connected to the reset signal, and a drain of the second reset switch is connected to a source of the third reset switch and a second end of the storage capacitor;
wherein a source of the third reset switch is connected to the drain of the second reset switch and the second end of the storage capacitor, a gate of the third reset switch is connected to the reset signal, and a drain of the third reset switch is connected to a drain of the driving transistor and an anode of the organic light-emitting diode;
wherein a source of the control switch is connected to the power line and the first end of the coupling capacitor, a gate of the control switch is connected to a driving signal, and the drain of the control switch is connected to the drain of the first reset switch and the source of the driving transistor; and
wherein the source of the driving transistor is connected to the drain of the first reset switch and the drain of the control switch, the drain of the driving transistor is connected to the third reset switch and the anode of the organic light-emitting diode, and a gate of the driving transistor is connected to the second end of the storage capacitor.

2. The pixel driving circuit according to claim 1, wherein when the reset signal is at a low voltage level, the first reset switch, the second reset switch, and the third reset switch are turned on, and the storage capacitor is set to store a threshold voltage of the driving transistor.

3. The pixel driving circuit according to claim 2, wherein the storage capacitor is set to discharge through the first reset switch and the driving transistor until charges stored therein are completely discharged, so as to store the threshold voltage in the storage capacitance.

4. The pixel driving circuit according to claim 3, wherein before the storage capacitor discharges through the first reset switch and the driving transistor, the voltage difference across the storage capacitor is larger than the threshold voltage.

5. The pixel driving circuit according to claim 2, wherein after the threshold voltage of the driving transistor is stored in the storage capacitor, the data line is used to set an input signal of the scan control line at a low voltage level and write in gray-scale data voltage when the reset signal is set at a high voltage level.

6. The pixel driving circuit according to claim 5, wherein after the data line writes in the gray-scale data voltage, the organic light-emitting diode is used to set the driving signal at a low voltage level and the input signal of the scan control line is set at a high voltage level, and emit light when the reset signal is set at a high voltage level.

7. The pixel driving circuit according to claim 1, wherein each of the scanning switch, the first reset switch, the second reset switch, the third reset switch, the control switch, and the driving transistor is a poly-silicon thin-film transistor, an anmorphous-silicon thin-film transistor, a ZnO-based thin-film transistor, or an organic thin-film transistor.

8. The pixel driving circuit according to claim 1, wherein both of the reset signal and the driving signal are provided by a timing controller.

9. The pixel driving circuit according to claim 1, wherein the reference voltage is a predetermined constant voltage.

10. A liquid crystal display device, comprising;
a pixel driving circuit, wherein the pixel driving circuit comprises:
a scanning switch;
a first reset switch;
a second reset switch;
a third reset switch;
a control switch;
a driving transistor;
an organic light-emitting diode; and
a storage capacitor and a coupling capacitor;
wherein a first end of the coupling capacitor is connected to a power line;
wherein a source of the scanning switch is connected to a data line, a gate of the scanning switch is connected to a scan control line, and a drain of the scanning switch is connected to a second end of the coupling capacitor and a first end of the storage capacitor;
wherein a source of the first reset switch is connected to the second end of the coupling capacitor and the first end of the storage capacitor, a gate of the first reset switch is connected to a reset signal, and a drain of the first reset switch is connected to a drain of the control switch and a source of the driving transistor;
wherein a source of the second reset switch is connected to a reference voltage, a gate of the second reset switch is connected to the reset signal, and a drain of the second reset switch is connected to a source of the third reset itch and a second end of the storage capacitor;
wherein a source of the third reset switch is connected to the drain of the second reset switch and the second end of the storage capacitor, a gate of the third reset switch is connected to the reset signal, and a drain of the third reset switch is connected to a drain of the driving transistor and an anode of the organic light-emitting diode;
wherein a source of the control switch is connected to the power line and the first end of the coupling capacitor, a gate of the control switch is connected to a driving signal, and the drain of the control switch is connected to the drain of the first reset switch and the source of the driving transistor; and
wherein the source of the driving transistor is connected to the drain of the first reset switch and the drain of the control switch, the drain of the driving transistor is connected to the third reset switch and the anode of the organic light-emitting diode, and a gate of the driving transistor is connected to the second end of the storage capacitor.

11. The liquid crystal display device according to claim 10, wherein when the reset signal is at a low voltage level, the first reset switch, the second reset switch, and the third reset switch are turned on, and the storage capacitor is set to store a threshold voltage of the driving transistor.

12. The liquid crystal display device according to claim 11, wherein the storage capacitor is set to discharge through the first reset switch and the driving transistor until charges stored therein are completely discharged, so as to store the threshold voltage in the storage capacitance.

13. The liquid crystal display device according to claim 12, wherein before the storage capacitor discharges through the first reset switch and the driving transistor, the voltage difference across the storage capacitor is larger than the threshold voltage.

14. The liquid crystal display device according to claim 11, wherein after the threshold voltage of the driving transistor is stored in the storage capacitor, the data line is used to set an input signal of the scan control line at a low voltage level and write in gray-scale data voltage when the reset signal is set at a high voltage level.

15. The liquid crystal display according to claim 14, wherein after the data line writes in the gray-scale data voltage, the organic light-emitting diode is used to set the driving signal at a low voltage level and the input signal of the scan control line is set at a high voltage level, and emit light when the reset signal is set at a high voltage level.

16. The liquid crystal display device according to claim 10, wherein each of the scanning switch, the first reset switch, the second reset switch, the third reset switch, the control switch, and the driving transistor is a poly-silicon thin-film transistor, an anmorphous-silicon thin-film transistor, a ZnO-based thin-film transistor, or an organic thin-film transistor.

17. The liquid crystal display device according to claim 10, wherein both of the reset signal and the driving signal are provided by a timing controller.

18. The liquid crystal display device according to claim 10, wherein the reference voltage is a predetermined constant voltage.
